(19) United States
(12) Patent Application Publication
(10) Pub. No.: US 2013/0250063 A1
(43) Pub. Date: Sep. 26, 2013

(54) BABY MONITORING SYSTEM AND METHOD

(71) Applicants: HOU-HSIEN LEE, Tu-Cheng (TW); CHANG-JUNG LEE, Tu-Cheng (TW); CHIH-PING LO, Tu-Cheng (TW)

(72) Inventors: HOU-HSIEN LEE, Tu-Cheng (TW); CHANG-JUNG LEE, Tu-Cheng (TW); CHIH-PING LO, Tu-Cheng (TW)

(73) Assignee: HON HAI PRECISION INDUSTRY CO., LTD., Tu-Cheng (TW)

(21) Appl. No.: 13/478,130

(22) Filed: May 23, 2012

(30) Foreign Application Priority Data
Mar. 26, 2012 (TW) 101110318

(51) Int. Cl. H04N 7/18; H04N 13/02

(52) U.S. Cl. 348/46

(57) ABSTRACT

An exemplary baby monitoring method includes obtaining an image captured by a camera. The image includes a distance information indicating distances between the camera and objects captured by the camera. The method then creates a 3D scene model according to the captured image and the distances between the camera and objects captured by the camera. Next, the method determines whether any baby appears in the created 3D scene model, and further determines whether the distances between the babies and electronic appliances are less than a preset value according to the distances between the camera and the babies, the distances between the camera and the electronic appliances, and a stored horizontal field of view of the camera. The method then outputs a warning and cuts off power supply to the electronic appliances whose distance to the one or more babies are less than the preset value.

### BACKGROUND

1. Technical Field

The present disclosure relates to baby monitoring systems, and particularly, to a baby monitoring system capable of preventing the baby from touching a dangerous electronic appliance and a method for monitoring the baby.

2. Description of Related Art

Some electronic appliances may be dangerous to babies who are naturally curious about their environment. Babies not in the immediate of their parents may touch some electronic appliances, which may harm the babies.

### BRIEF DESCRIPTION OF THE DRAWINGS

The components of the drawings are not necessarily drawn to scale, the emphasis instead being placed upon clearly illustrating the principles of the present disclosure. Moreover, in the drawings, like reference numerals designate corresponding parts throughout several views.

FIG. 1 is a schematic diagram illustrating a baby monitoring device connected with one camera in accordance with an exemplary embodiment.

FIG. 2 is a schematic view showing how to determine the distance between a baby and an electronic appliance.

FIGS. 3A-3C are a series of schematic views showing how to determine one or more monitoring electronic appliance.

FIG. 4 is a flowchart of a baby monitoring method in accordance with an exemplary embodiment.

### DETAILED DESCRIPTION

The embodiments of the present disclosure are described with reference to the accompanying drawings.

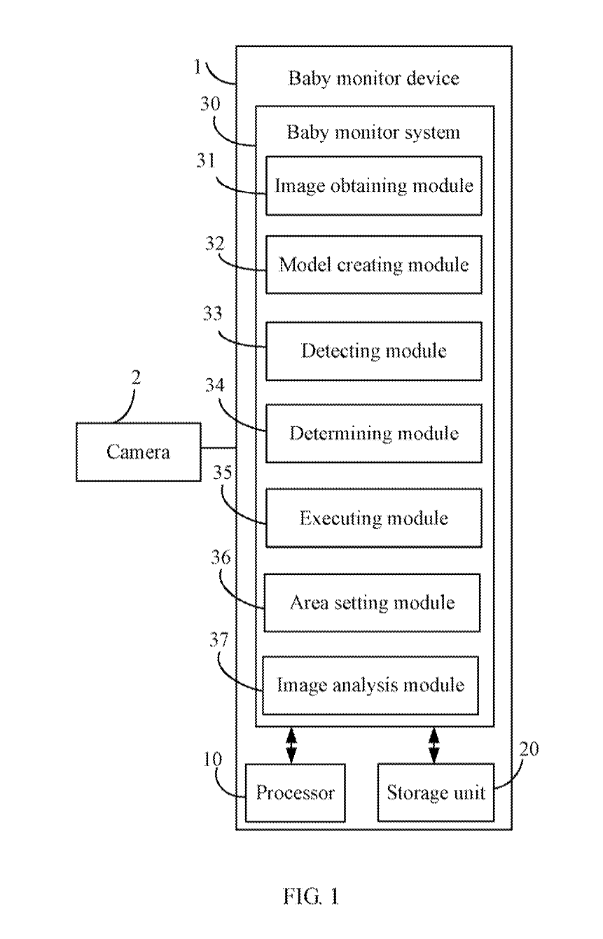

FIG. 1 is a schematic diagram illustrating a baby monitoring device 1 that can cut off the power of predetermined electronic appliances when a baby moves too close to the predetermined electronic appliances. The baby monitoring device 1 is connected to a camera 2. The baby monitoring device 1 can analyze an image captured by the camera 2 and determine whether one or more babies appear in the image when one or more determined electronic appliances is in the image, and further output a warning and cut off the power to one or more determined electronic appliances when a distance between the baby and the one or more determined electronic appliances is less than a preset value.

Each captured image shot by the camera 2 includes distance information indicating the distance between the camera 2 and any object in the field of view of the camera 2. In the embodiment, the camera 2 is a Time of Flight (TOF) camera.

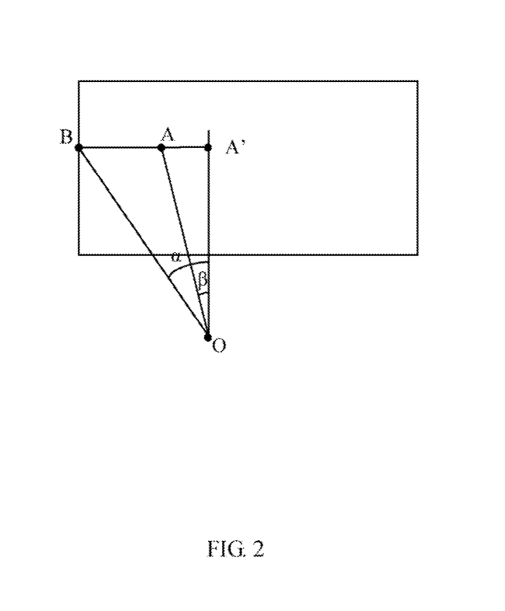

FIG. 2 shows the baby monitoring device 1 including a processor 10, a storage unit 20, and a baby monitoring system 30. In the embodiment, the baby monitoring system 30 includes an image obtaining module 31, a model creating module 32, a detecting module 33, a determining module 34, and an executing module 35. One or more programs of the above function modules may be stored in the storage unit 20 and executed by the processor 10. In general, the word “module,” as used herein, refers to logic embodied in hardware or firmware, or to a collection of software instructions, written in a programming language. The software instructions in the modules may be embedded in firmware, such as in an erasable programmable read-only memory (EPROM) device. The modules described herein may be implemented as either software and/or hardware modules and may be stored in any type of computer-readable medium or other storage device. The storage unit 20 further stores a number of three-dimensional (3D) baby modules and horizontal fields of view of the camera 2. Each 3D baby module has a number of characteristic features. The 3D baby models may be created based on a number of baby images pre-collected by the camera 2 and the distances between the camera 2 and the baby recorded in the pre-collected baby images.

The image obtaining module 31 can obtain an images captured by the camera 2.

The model creating module 32 can create a 3D scene model according to the obtained image and the distances between the camera 2 and any object in the field of view of the camera 2.

The detecting module 33 determines whether one or more babies appear in the created 3D scene model. In detail, the detecting module 33 extracts data from the created 3D scene model corresponding to the shape of the one or more objects appearing in the created 3D scene model, and compares each of the extracted data with characteristic features of each of the 3D baby models, to determine whether one or more babies appear in the created 3D scene model. If the extracted data does not match the data as to feature characteristics of any of the 3D baby models, the detecting module 33 determines that no baby is in the created 3D scene model. Otherwise, the detecting module 33 determines that one or more babies are in the created 3D scene model.

When one or more babies appear in the created 3D scene model, the determining module 34 determines whether one or more distances between the one or more babies and one or more electronic appliances being monitored are less than a preset value according to the distances between the camera 2 and the one or more babies, the distances between the camera 2 and the one or more electronic appliances being monitored, and the stored horizontal fields of view of the camera 2. In detail, the determining module 34 determines whether an absolute value of each of the one or more distances between the camera 2 and the one or more electronic appliance being monitored subtracted by one of the distances between the camera 2 and the one or more babies is more than a predetermined value. If so, the determining module 34 determines that one or more distances between the one or more babies and the one or more electronic appliances being monitored is more than the preset value.

If no absolute value of each of the one or more distances between the camera 2 and one or more electronic appliances being monitored subtracted by one of the distances between the camera 2 and the one or more babies is more than the predetermined value, the determining module 34 extends a line from the baby as recognized which is perpendicular to the optical axis of the camera 2 in the image and determines a first intersection point where the line intersects the optical axis of the camera 2. The determining module 34 further extends the line to the boundary of the image adjacent to the baby to form an extending line, and determines a second intersection point where the extending line intersects the boundary of the image, and further determines the ratio of the lengths formed by the baby and the second intersection point to the length formed by the baby and the first intersection point. The ratio of those lengths in the image will be the same as the ratio in fact. The determining module 34 determines the angle between the optical axis and the line formed by the camera 2 and the baby according to the determined ratio in fact and the stored horizontal field of view of the camera 2, and further determines the distance between the baby and the first intersection point according to the determined angle and the distance between the camera 2 and the baby.

For example, in FIG. 2, the camera 2 is represented by a point O, one baby is represented by a point A. The first intersection point is represented by a point A′, the second intersection point is represented by a point B, and the distance between the baby and the camera 2 is 10 meters. The ratio of the length of line AA′ in the image to the length of line AB in the image is 1:2, and the stored horizontal field of view of the camera 2 a is 60 degrees. Thus the determining module 34 determines that the angle β between line OA and line OA′ is 30°, and further determines that the length of AA′ in fact is 5 meters.

In the same way, the determining module determines the distance between one monitoring electronic appliance and a third intersection point where another line intersects the optical axis of the camera 2. That other line extends from the monitoring electronic appliance and is perpendicular to the optical axis of the camera 2. No absolute value of the result that the distance between the camera 2 and one monitoring electronic appliance, subtracts the distance between the camera 2 and one baby, is more than a preset value, then the distance between the baby and that particular electronic appliance can be considered as the actual distance in fact between the baby and the first intersection point adding the actual distance in fact between the monitoring electronic appliance and the second intersection point. By the same method, the determining module can determine the other distances between the other one or more babies and the other electronic appliances being monitored. The determining module 34 can further determine whether any of the determined distances between the one or more babies and the one or more electronic appliances being monitored is less than the preset value.

If an absolute values of each of the one or more distances between the camera 2 and some electronic appliances being monitored subtracted by one of the distances between the camera 2 and some babies are more than the predetermined value, and an absolute values of each of the one or more distances between the camera 2 and the other electronic appliances being monitored subtracted by one of the distances between the camera 2 and the other babies are less than the predetermined value, the determining module 34 determines that the distances between the some babies and the some electronic appliances being monitored are more than the preset value, determines the distances between the other babies and the other electronic appliances being monitored, in the same way as that no absolute value of the result is more than the predetermined value, and further determines whether the determined distances between the other babies and the other electronic appliances being monitored are less than the preset value.

When the determining module 34 determines that one or more distances between one or more babies and an one or more electronic appliances being monitored are less than the preset value, the executing module 35 output a warning and cuts off power supply to the one or more electronic appliances being monitored which are deemed to be too close to the one or more babies according to the preset value.

In the first embodiment, the storage unit 20 further stores a map. The map includes information as to a number of electronic appliances in different locations. Information as to each electronic appliance is pre-collected by capturing images using the camera 2 in one location.

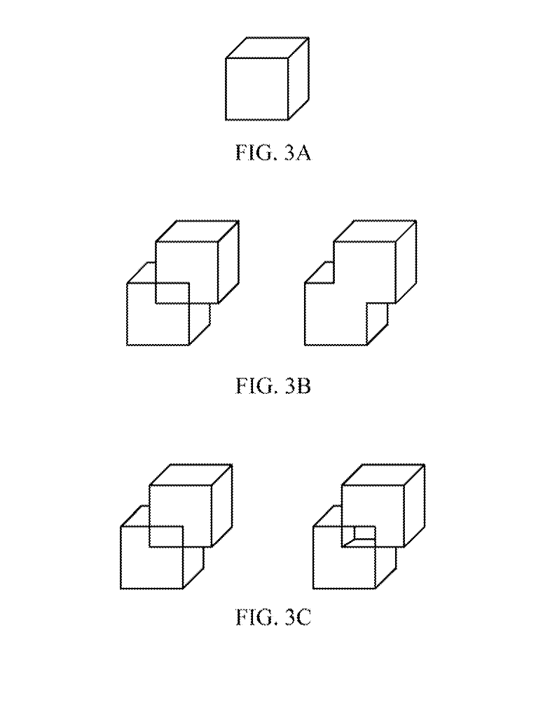

The baby monitoring system 30 further includes an area setting module 36. The area setting module 36 is to obtain the map from the storage unit 20 in response to a user selection, obtain the image of a desired location from the map in response to a user selection, and determine which electronic appliance being monitored in accordance with user selections. In the embodiment, the user selections include a first selection, a second selection, and a third selection. The first selection is an operation to select a single electronic appliance in the image (see FIG. 3A). The second selection is a series of operations to select two or more electronic appliances in the image (see FIG. 3B). The third selection is a series of operations to select objects which overlap another object by subtracting a first object from a second object in the image (see FIG. 3C). In FIGS. 3B-3C, the right-hand figures show which of the one or more electronic appliances are to be monitored after selection(s) have been made.

In the second embodiment, the storage unit 20 stores a number of 3D views of electronic appliances. Each 3D view of an electronic appliance has a number of characteristic features. The 3D view(s) of electronic appliances may be created based on a number of images of electronic appliance shot by the camera 2 and the distances between the camera 2 and each of the electronic appliances recorded in the pre-collected images of electronic appliances.

The baby monitoring system 30 further includes an image analysis module 37. The image analysis module 37 detects whether one or more electronic appliances being monitored appear in fact in the created 3D scene model. In detail, the image analysis module 37 extracts any data from the created 3D scene model which corresponds to the shape of the one or more objects appearing in the created 3D scene model, and compares extracted data with characteristic features of each of the 3D views of electronic appliances, to determine whether one or more electronic appliances being monitored is actually in the created 3D scene model. If the extracted data does not match any data as to characteristic features of any of the 3D views of electronic appliances, the image analysis module 37 determines that no electronic appliance is in the created 3D scene model. Otherwise, the image analysis module 37 determines that one or more electronic appliances being monitored are present in the created 3D scene model.

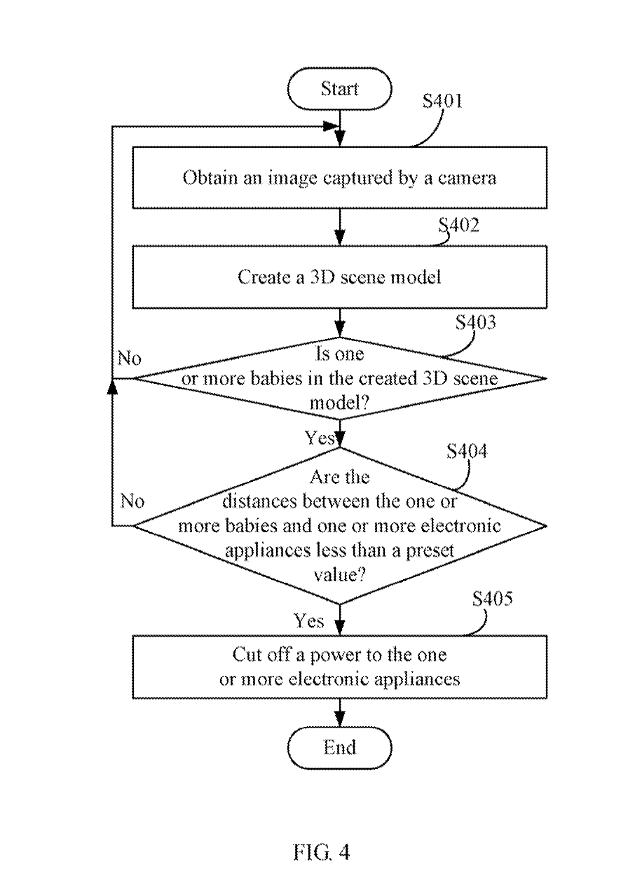

FIG. 4 shows a flowchart of a baby monitoring method in accordance with an exemplary embodiment.

In step S401, the image obtaining module 31 obtains the images captured by the camera 2.

In step S402, the model creating module 32 creates a 3D scene model according to the obtained images, referring to the distances between the camera 2 and any object in the field of view of the camera 2.

In step S403, the detecting module 33 detects the presence of any baby in the created 3D scene model. When one or more babies appear in the created 3D scene model, the procedure goes to step S404. Otherwise, the procedure goes to step S401. In detail, the detecting module 33 extracts data from the created 3D scene model corresponding to the shape of the one or more objects, and compares the extracted data with data as to the characteristics of features of each of the 3D baby models, to determine whether one or more babies is in the created 3D scene model. If the extracted data does not match the data as to characteristic features of any of the 3D baby models, the detecting module 33 determines that no baby is in the created 3D scene model. If the extracted data matches any data as to characteristics of features of one 3D view of a baby, the detecting module 33 determines that one or more babies are in the created 3D scene model.

In step S404, the determining module 34 determines whether the one or more distances between the one or more babies and one or more electronic appliances being monitored are less than a preset value according to the distances between the camera 2 and the one or more babies, the distances between the camera 2 and the one or more electronic appliances being monitored, and the stored horizontal fields of view of the camera 2. If the one or more distances between the one or more babies and the one or more electronic appliances being monitored are less than the preset value, the procedure goes to step S405. Otherwise, the procedure goes to step S401.

In step S405, the executing module 35 outputs an warning and cuts off power supply to the one or more electronic appliances being monitored which is determined to be at a distance less than the preset value from the one or more babies.

In a first embodiment, the image obtaining module 31 obtains captured images after the area setting module 36 has allowed for the presence of one or more electronic appliances.

In detail, the area setting module 36 obtains the map from the storage unit 20 in response to a user operation, obtains the image of a desired place from the map in response to a user operation, and determines the one or more electronic appliances being monitored in response to a user operation. In the embodiment, the above user operations include a first selection, a second selection, and a third selection. The first selection is an operation to select a single electronic appliance in the image (see FIG. 3A). The second selection is a series of operations to select two or more electronic appliances in the image (see FIG. 3B). The third selection is a series of operations to select objects which overlap by subtracting a first object from a second object in the image (see FIG. 3C). In FIGS. 3B-3C, the right-hand figures show the particular electronic appliances after selection which are to be monitored.

In a second embodiment, the detecting module 33 detecting whether one or more babies is in the created 3D scene model is performed after the image analysis module 37 has determined that one or more electronic appliances do in fact appear in the created 3D scene model.

In detail, the image analysis module 37 detects whether one or more electronic appliances being monitored are in the created 3D scene model. In detail, the image analysis module 37 extracts data from the created 3D scene model corresponding to the shape of the one or more objects, and compares the extracted data with characteristic features from each of the 3D views of electronic appliances, to determine whether one or more electronic appliances being monitored do appear in the created 3D scene model. If the extracted data does not match the data as to characteristic features of any of the 3D views of the electronic appliances, the image analysis module 37 determines that no electronic appliance is in the created 3D scene model. Otherwise, the image analysis module 37 determines that one or more electronic appliances being monitored are in fact in the created 3D scene model.

Although the present disclosure has been specifically described on the basis of an exemplary embodiment thereof, the disclosure is not to be construed as being limited thereto. Various changes or modifications may be made to the embodiment without departing from the scope and spirit of the disclosure.

What is claimed is:

1. A baby monitoring device comprising:
a storage unit;
a processor;
one or more programs stored in the storage unit, executable by the processor, the one or more programs comprising:
an image obtaining module operable to obtain an image captured by a camera, the image comprising a distance information indicating distances between the camera and objects captured by the camera;
a model creating module operable to create a 3D scene model according to the captured image and the distances between the camera and objects captured by the camera;
a detecting module operable to determine whether one or more babies appear in the created 3D scene model, and further to determine whether the one or more distances between the one or more babies and one or more electronic appliances being monitored are less than a preset value according to the distances between the camera and the one or more babies, the distances between the camera and the one or more electronic appliances being monitored, and a stored horizontal field of view of the camera; and
an executing module operable to output a warning and cut off power supply to the one or more electronic appliances being monitored whose distances to the one or more babies are less than the preset value.

2. The baby monitoring device as described in claim 1 further comprising an area setting module, wherein the area setting module is operable to obtain a map from the storage unit in response to a user selection, obtain the image of a desired location from the map in response to the user selection, and determine which electronic appliance being monitored in accordance with user selections.

3. The baby monitoring device as described in claim 2, wherein the user selections comprises a first selection, a second selection, and a third selection, the first selection is an operation to select a single electronic appliance in the image, the second selection is a series of operations to select two or more electronic appliances in the image, and the third selection is a series of operations to select objects which overlap another object by subtracting a first object from a second object in the image.

4. The baby monitoring device as described in claim 1 further comprising an image analysis module, wherein the image analysis module is operable to extract data from the created 3D scene model which corresponds to the shape of the one or more objects appearing in the created 3D scene model, and compare the extracted data with characteristic features of each of the 3D views of electronic appliances, to determine whether one or more electronic appliances being monitored are present in the created 3D scene model.

5. The baby monitoring device as described in claim 1, wherein when an absolute value of each of the one or more distances between the camera and the one or more electronic appliances being monitored subtracted by one of the distances between the camera and the one or more babies is more than a predetermined value, the determining module is operable to determine that one or more distances between the one or more babies and the one or more electronic appliances being monitored is more than the preset value.

6. The baby monitoring device as described in claim 1, wherein when no absolute value of each of the one or more distances between the camera and the one or more electronic appliances being monitored subtracted by one of the distances between the camera and the one or more babies is more than a predetermined value, the determining module is operable to:
extend a line from the baby which is perpendicular to the optical axis of the camera in the image and determine a first intersection point where the line intersects the optical axis of the camera;
extend the line to the boundary of the image adjacent to the baby to form an extending line and determine a second intersection point where the extending line intersects the boundary of the image;
determine the ratio in the image of the length formed by the baby and the another intersection point to the length formed by the baby and the intersection point, and determine the ratio in fact of the length formed by the baby and the second intersection point to the length in the image formed by the baby and the first intersection point which is the same as the ratio in the image;
determine the angle between the optical axis and the line formed by the camera and the baby according to the determined ratio in fact and the stored horizontal field of view of the camera, and further determine the distance between the baby and the first intersection point according to the determined angle and the distance between the camera and the baby;
determine the distance between the monitoring electronic appliance and a third intersection point where another line intersects the optical axis of the camera, another line extends from the monitoring electronic appliance and is perpendicular to the optical axis of the camera;
consider the distance between the baby and the monitoring electronic appliance as the actual distance in fact between the baby and the first intersection point adding the actual distance in fact between the monitoring electronic appliance and the second intersection point, because no absolute value of the result that the distance between the camera and the monitoring appliance, subtract the distance between the camera and the baby, is more than a preset value;
determine the other distances between the other one or more babies and the other one or more electronic appliances being monitored; and
determine whether any of the determined distances between the one or more babies and the one or more electronic appliances being monitored is less than the preset value.

7. The baby monitoring device as described in claim 6, wherein when an absolute values of each of the one or more distances between the camera and some electronic appliances being monitored subtracted by one of the distances between the camera and some babies are more than the predetermined value, and an absolute values of each of the one or more distances between the camera and the other electronic appliances being monitored subtracted by one of the distances between the camera and the other babies are less than the predetermined value, the determining module is operable to determine that the distances between the some babies and the some electronic appliances being monitored are more than the preset value, determine the distances between the other babies and the other electronic appliances being monitored, in the same way as that no absolute value of the result is more than the predetermined value, and further determine whether the determined distances between the other babies and the other electronic appliances being monitored are less than the preset value.

8. A baby monitoring method comprising:
obtaining an image captured by a camera, the image comprising a distance information indicating distances between the camera and objects captured by the camera;
creating a 3D scene model according to the captured image and the distances between the camera and objects captured by the camera;
determining whether one or more babies appear in the created 3D scene model, and further determining whether the one or more distances between the one or more babies and one or more electronic appliances being monitored are less than a preset value according to the distances between the camera and the one or more babies, the distances between the camera and the one or more electronic appliances being monitored, and a stored horizontal field of view of the camera; and
outputting a warning and cutting off power supply to the one or more electronic appliances being monitored whose distance to the one or more babies are less than the preset value.

9. The baby monitoring method as described in claim 8, wherein the method further comprises:
obtaining a map from the storage unit in response to a user selection, obtaining the image of a desired location from the map in response to the user selection, and determining which electronic appliance being monitored in accordance with user selections.

10. The baby monitoring method as described in claim 8, wherein the method further comprises:
extracting data from the created 3D scene model which corresponds to the shape of the one or more objects appearing in the created 3D scene model, and comparing the extracted data with characteristic features of each of the 3D views of electronic appliances, to determine whether one or more electronic appliances being monitored are present in the created 3D scene model.

11. The baby monitoring method as described in claim 8, wherein the method further comprises:
determining that one or more distances between the one or more babies and the one or more electronic appliances being monitored is more than the preset value, when an absolute value of each of the one or more distances between the camera and the one or more electronic appliance being monitored subtracted by one of the distances between the camera and the one or more babies is more than a predetermined value.

12. The baby monitoring method as described in claim 8, wherein the method further comprises:
extending a line from the baby which is perpendicular to the optical axis of the camera in the image and determining a first intersection point where the line intersects the optical axis of the camera, when no absolute value of each of the one or more distances between the camera and the one or more electronic appliances being monitored subtracted by one of the distances between the camera and the one or more babies is more than a predetermined value;
extending the line to the boundary of the image adjacent to the baby to form an extending line and determining a second intersection point where the extending line intersects the boundary of the image;
determining the ratio in the image of the length formed by the baby and the another intersection point to the length formed by the baby and the intersection point, and determining the ratio in fact of the length formed by the baby and the second intersection point to the length in the image formed by the baby and the first intersection point which is the same as the ratio in the image;
determining the angle between the optical axis and the line formed by the camera and the baby according to the determined ratio in fact and the stored horizontal field of view of the camera, and further determining the distance between the baby and the first intersection point according to the determined angle and the distance between the camera and the baby;
determining the distance between the monitoring electronic appliance and a third intersection point where another line intersects the optical axis of the camera, another line extends from the monitoring electronic appliance and is perpendicular to the optical axis of the camera;
considering the distance between the baby and the monitoring electronic appliance as actual distance in fact between the baby and the first intersection point adding the actual distance in fact between the monitoring electronic appliance and the second intersection point, because no absolute value of the result that the distance between the camera and the monitoring electronic appliance, subtract the distance between the camera and the baby, is more than a preset value;
determining the other distances between the other one or more babies and the other one or more electronic appliances being monitored; and
determining whether any of the determined distances between the one or more babies and the one or more electronic appliances being monitored are less than the preset value.

13. The baby monitoring method as described in claim 12, wherein the method further comprises:
determining that the distances between the some babies and the some electronic appliances being monitored are less than the preset value, when an absolute values of each of the one or more distances between the camera and some electronic appliances being monitored subtracted by one of the distances between the camera and some babies are more than the predetermined value, and an absolute values of each of the one or more distances between the camera and the other electronic appliances being monitored subtracted by one of the distances between the camera and the other babies are less than the predetermined value;
determining the distances between the other babies and the other electronic appliances being monitored, in the same way as that no absolute value of the result is more than the predetermined value; and
determining whether the determined distances between the other babies and the other electronic appliances being monitored are less than the preset value.

14. A non-transitory storage medium storing a set of instructions, the set of instructions capable of being executed by a processor of a baby monitoring device, cause the baby monitoring device to perform a baby monitoring method, the method comprising:
obtaining an image captured by a camera, the image comprising a distance information indicating distances between the camera and objects captured by the camera;
creating a 3D scene model according to the captured image and the distances between the camera and objects captured by the camera;
determining whether one or more babies appear in the created 3D scene model, and further determining whether the one or more distances between the one or more babies and one or more electronic appliances being monitored are less than a preset value according to the distances between the camera and the one or more babies, the distances between the camera and the one or more electronic appliances being monitored, and a stored horizontal field of view of the camera; and
outputting a warning and cutting off power supply to the determined one or more electronic appliances being monitored whose distance to the one or more babies are less than the preset value.

15. The non-transitory storage medium as described in claim 14, wherein the method further comprises:
obtaining a map from the storage unit in response to the user selection, obtaining the image of a desired location from the map in response to a user selection, and determining which electronic appliance being monitored in accordance with user selections.

16. The non-transitory storage medium as described in claim 14, wherein the method further comprises:
extracting data from the created 3D scene model which corresponds to the shape of the one or more objects appearing in the created 3D scene model, and comparing the extracted data with characteristic features of each of the 3D views of electronic appliances, to determine whether one or more electronic appliances being monitored are present in the created 3D scene model.

17. The non-transitory storage medium as described in claim 14, wherein the method further comprises:
determining that one or more distances between the one or more babies and the one or more electronic appliances being monitored is more than the preset value, when an absolute value of each of the one or more distances between the camera and the one or more electronic appliances being monitored subtracted by one of the distances between the camera and the one or more babies is more than a predetermined value.

18. The non-transitory storage medium as described in claim 14, wherein the method further comprises:
extending a line from the baby which is perpendicular to the optical axis of the camera in the image and determining a first intersection point where the line intersects the optical axis of the camera, when no absolute value of each of the one or more distances between the camera and the one or more electronic appliances being monitored subtracted by one of the distances between the camera and the one or more babies is more than a predetermined value;
extending the line to the boundary of the image adjacent to the baby to form an extending line and determining a second intersection point where the extending line intersects the boundary of the image;
determining the ratio in the image of the length formed by the baby and the another intersection point to the length formed by the baby and the intersection point, and determining the ratio in fact of the length formed by the baby and the second intersection point to the length in the image formed by the baby and the first intersection point which is the same as the ratio in the image;
determining the angle between the optical axis and the line formed by the camera and the baby according to the determined ratio in fact and the stored horizontal field of view of the camera, and further determining the distance between the baby and the first intersection point according to the determined angle and the distance between the camera and the baby;
determining the distance between the monitoring electronic appliance and a third intersection point where another line intersects the optical axis of the camera, another line extends from the monitoring electronic appliance and is perpendicular to the optical axis of the camera;
considering the distance between the baby and the monitoring electronic appliance as the actual distance in fact between the baby and the first intersection point adding the actual distance in fact between the monitoring electronic appliance and the second intersection point, because no absolute value of the result that the distance between the camera and the monitoring electronic appliance, subtract the distance between the camera and the baby, is more than a preset value;
determining the other distances between the other one or more babies and the other one or more electronic appliances being monitored; and
determining whether any of the determined distances between the one or more babies and the one or more electronic appliances being monitored is less than the preset value.

19. The non-transitory storage medium as described in claim 18, wherein the method further comprises:
determining that the distances between the some babies and the some electronic appliances being monitored are less than the preset value when an absolute values of each of the one or more distances between the camera and some electronic appliances being monitored subtracted by one of the distances between the camera and some babies are more than the predetermined value, and an absolute values of each of the one or more distances between the camera and the other electronic appliances being monitored subtracted by one of the distances between the camera and the other babies are less than the predetermined value;
determining the distances between the other babies and the other electronic appliances being monitored, in the same way as that no absolute value of the results is more than the predetermined value; and
determining whether the determined distances between the other babies and the other electronic appliances being monitored are less than the preset value.
